(19) United States
(12) Patent Application Publication
(10) Pub. No.: US 2025/0149785 A1
(43) Pub. Date: May 8, 2025

(54) DUAL POLARIZED PHASED ARRAY ANTENNA

(71) Applicant: Elta Systems Ltd., Ashdod (IL)

(72) Inventor: Reuven BAUER, Rehovot (IL)

(21) Appl. No.: 18/907,942

(22) Filed: Oct. 7, 2024

(30) Foreign Application Priority Data
Nov. 7, 2023 (IL) 308374

(51) Int. Cl. H01Q 3/38; H01Q 1/48; H01Q 3/26; H01Q 9/04

(52) U.S. Cl. CPC H01Q 3/38; H01Q 1/48; H01Q 9/0414; H01Q 3/267

(57) ABSTRACT

A patch antenna includes: an upper patch radiator, a lower patch radiator beneath the upper patch radiator, an upper feed layer beneath the lower patch radiator, a ground plane beneath the upper feed and a lower feed layer beneath the ground plane. The upper feed layer couples a first feed line to the upper patch radiator. The ground plane has slot apertures in orthogonal directions, to obtain orthogonal polarizations. The lower feed layer couples a second feed line to the lower patch radiator. The upper feed layer is coupled to the lower patch radiator via the ground plane slot aperture in one direction, and the lower feed layer is coupled to the lower patch radiator via the ground plane slot aperture in an orthogonal direction.

### TECHNICAL FIELD

The present disclosure, in some embodiments, thereof, relates to a phased array antenna and, more particularly, but not exclusively, to a dual polarized phased array antenna.

### BACKGROUND

Wireless mobile communication networks are becoming increasingly complex and demanding. In order to meet the needs of these networks, antenna systems must be able to provide high-quality coverage and performance over a wide range of conditions.

One way to achieve this is to use dual polarized phased array antennas. Dual polarized antennas can transmit and receive signals in two polarizations, thus providing more reliable coverage.

Phased array antennas are capable of beam steering. This means that they can electronically steer the radiation pattern of the antenna in a desired direction. Beam steering can electronically steer a beam in different directions without moving the antenna.

Many dual-polarized phased array antennas need high isolation between polarizations. Typically, microstrip printed phased array antennas are not able to meet these requirements and therefore more complicated antennas are used (such as magneto-electric, Vivaldi and so forth). Magneto-electric antennas have a mechanically difficult design and are expensive to manufacture. Vivaldi antennas are non-resonant and its bandwidth is too large for many applications.

Additional background art includes:
1) J. Lu, Z. Kuai, X. Zhu and N. Zhang, “A High-Isolation Dual-Polarization Microstrip Patch Antenna with Quasi-Cross-Shaped Coupling Slot,” in IEEE Transactions on Antennas and Propagation, vol. 59, no. 7, pp. 2713-2717 July 2011, doi: 10.1109/TAP.2011.2152333.

Acknowledgement of the above references herein is not to be inferred as meaning that these are in any way relevant to the patentability of the presently disclosed subject matter.

### SUMMARY OF THE INVENTION

There is a need for a high-performance dual-polarized phased array antenna formed of compact, easily manufactured antennas.

According to some embodiments there are provided an antenna, an antenna array, a method for steering an antenna array, and a system and method for calibrating a dual-polarization antenna array, and any combination thereof. Embodiments presented herein address the deficiencies of conventional phased array antenna systems and provide a novel antenna with high isolation between polarizations. Isolation of greater than −18 dB has been obtained over a scan volume of ±60° azimuth and ±60° elevation.

According to some embodiments of the present invention, upper and lower patches of a patch antenna are excited using an aperture coupled feed with substantially orthogonal slots as described below. One polarization excites the patch by placing the feed below the aperture, while the second polarization excites the patch by placing the feed above the aperture. The apertures are etched within the ground plane. The ground plane separates the feeds of each polarization, enabling the antenna to achieve a high isolation between the two polarizations.

Different polarizations may be obtained by rotating the angle of orthogonal slots relative to the sides of the patch. In some embodiments, the slots are located substantially on the diagonals of the patch, thereby obtaining +45° and −45° polarizations.

In some embodiments of the invention, a phased array antenna is formed from patch antennas as described herein. The antenna radiation pattern is controlled by adjusting the relative phases and amplitudes of each patch antenna. Phased array antennas are often used for beam and/or null steering.

Phased array antennas are often calibrated to ensure that the amplitude and phase adjustments for each of the antennas are accurate, so that the desired radiation pattern is produced. However, calibration may be complex to implement and time-consuming. These problems are particularly acute in dual-polarized antennas, in which phase and amplitude corrections must be determined for each polarization. Typically, dual-polarized phased array antennas have two calibration networks, one for each polarization.

In some embodiments of the invention, both polarizations of the patch antennas are calibrated using a single calibration network (rather than a separate calibration network for each polarization). A calibration line is placed adjacent to patch antennas with polarizations rotated relative to the 0° and 90° polarizations that are typically used in patch antennas (e.g. patch antennas with +45° and −45° polarizations). Because the calibration line is not perpendicular to either one of the polarizations, the calibration line is coupled to both polarizations, and the calibration output signals obtained using a single calibration line may be analyzed to determine the required correction factors for each individual polarization.

Technical effects of some embodiments of the invention include one or more of:
1) High-performance phased array antenna with relatively wide bandwidth and capable of high-power operation;
2) Easily manufactured microstrip printed antennas and antenna elements;
3) Uses a single calibration network for both polarizations, resulting in reduced spatial requirements and less complex antenna architecture;
4) Capable of operating in many types of systems (e.g. radar, 5G cellular network communications, satellite communications, etc.);
5) The antenna is resonant. As a result, it only operates over a specific frequency range. This ensures that it does interfere with other systems. Other dual-polarized antennas (e.g. Vivaldi) are non-resonant and operate over a very wide bandwidth, which may be detrimental to nearby systems.
6) High isolation polarization due to the physical separate of the signal feed.

According to a first aspect of some embodiments of the present invention there is provided patch antenna which includes multiple stacked antenna elements. Each of the stacked antenna elements respectively include:
an upper patch radiator;
a lower patch radiator beneath the upper patch radiator;
an upper feed layer beneath the lower patch radiator, configured to couple a first feed line to the upper patch radiator;
a ground plane beneath the upper feed, having at least one slot aperture along the ground plane in a first direction and at least one slot aperture along the ground plane in a second directional orthogonal to the first direction so as to obtain orthogonal polarizations; and
a lower feed layer beneath the ground plane, configured to couple a second feed line to the lower patch radiator,
wherein the upper feed layer is coupled to the lower patch radiator via the at least one slot aperture along the ground plane in the first direction and the lower feed layer is coupled to the lower patch radiator via the at least one slot aperture along the ground plane in the second direction.

According to some embodiments of the invention, the antenna elements are located within a cavity.

According to some embodiments of the invention the patch antenna further includes a top dielectric layer above the upper patch radiator.

According to some embodiments of the invention, the first direction and the second direction are aligned with diagonals of the ground plane, so that the upper patch radiator and the lower patch radiator have +45 degree polarization and-45 degree polarization respectively.

According to some embodiments of the invention, the orthogonal directions are rotated relative to the horizontal and vertical axes of the ground plane.

According to some embodiments of the invention the patch antenna further includes a first transmit/receive (T/R) module configured for adjusting at least one of a phase and an amplitude of a signal applied to the upper feed layer and a second T/R module configured for adjusting at least one of a phase and an amplitude of a signal applied to the lower feed layer.

According to some embodiments of the invention, the upper patch radiator is separated from the lower patch radiator by one of an air gap and a dielectric layer.

According to some embodiments of the invention, the lower patch radiator is separated from the upper feed layer by one of an air gap and a dielectric layer.

According to some embodiments of the invention the patch antenna further includes a first substrate layer between the upper feed layer and the ground plane.

According to some embodiments of the invention the patch antenna further includes a second substrate layer between the lower feed layer and the ground plane.

According to some embodiments of the invention, the upper patch radiator and the lower patch radiator are metallic layers.

According to some embodiments of the invention, the patch antenna further includes a mechanical support element supporting the upper first patch radiator and the lower patch radiator over the ground plane through their respective centers.

According to a second aspect of some embodiments of the present invention there is provided a phased array antenna. The phased array antenna includes an array of patch antennas. Each of the patch antennas respectively includes:
an upper patch radiator;
a lower patch radiator below the upper patch radiator; and
a ground plane below the lower patch radiator, the ground plane including at least one slot aperture along the ground plane in a first direction and at least one slot aperture along the ground plane in a second direction substantially orthogonal to the first direction, wherein the lower patch radiator is coupled to an upper feed layer positioned between the lower patch radiator and the ground plane and to a lower feed layer positioned below the ground plane via slot apertures along respective ones of the orthogonal directions; and
multiple transmit/receive (T/R) modules associated with the respective upper feed layers and the respective lower feed layers of the multiple patch antennas, configured to adjust at least one of a respective phase and a respective amplitude of signals applied to the upper patch radiators and to the lower patch radiators in accordance with respective control signals, so as to steer a beam of the phased array antenna.

According to some embodiments of the invention, each of the patch antennas is located in a respective cavity.

According to some embodiments of the invention, each of the patch antennas includes a respective top dielectric layer above the upper patch radiator.

According to some embodiments of the invention, the antenna array further includes a beam steering controller configured to generate the control signals so as to obtain a specified scan angle.

According to some embodiments of the invention, for at least one of the patch antennas the upper patch radiator and the lower patch radiator are configured to have +45degree polarization and −45 degree polarization respectively.

According to some embodiments of the invention, for at least one of the patch antennas the orthogonal directions are rotated relative to the horizontal and vertical axes of the ground plane.

According to some embodiments of the invention, the antenna array further includes at least one calibration line running between the multiple patch antennas, wherein, for at least one of the patch antennas, propagation parameters for both the upper feed layer and the lower feed layer are calibrated using the same calibration line.

According to a third aspect of some embodiments of the present invention there is provided a method for steering a phased array antenna. The method includes:
generating respective control signals for a phased array antenna, where the phased array antenna includes:
an array of patch antennas configured to emit orthogonally polarized signals, where each of the patch antennas respectively includes:
an upper patch radiator;
a lower patch radiator below the upper patch radiator; and
a ground plane below the lower patch radiator, the ground plane includes at least one slot aperture along the ground plane in a first direction and at least one slot aperture along the ground plane in a second direction substantially orthogonal to the first direction, wherein the lower patch radiator is coupled to an upper feed layer positioned between the lower patch radiator and the ground plane and to a lower feed layer positioned below the ground plane via slot apertures along respective ones of the orthogonal directions; and multiple transmit/receive (T/R) modules associated with the respective upper feed layers and the respective lower feed layers of the multiple patch antennas, configured to adjust at least one of a respective phase and a respective amplitude signals applied to the upper patch radiators and to the lower patch radiators in accordance with respective control signals; and
providing the generated control signals to the respective T/R modules so as to obtain a specified scan angle.

According to some embodiments of the invention, for at least one of the patch antennas the upper patch radiator and the lower patch radiator are configured to have +45degree polarization and −45 degree polarization respectively.

According to some embodiments of the invention, each of the patch antennas is located in a respective cavity.

According to some embodiments of the invention, each of the patch antennas includes a respective top dielectric layer above the upper patch radiator.

According to some embodiments of the invention, the phased array patch antenna further includes at least one calibration line running between the multiple patch antennas, and the method further includes calculating respective correction factors for each of the polarizations using a same calibration line.

According to a fourth aspect of some embodiments of the present invention there is provided a method for calibrating a phased array antenna. The phased array antenna includes an array of patch antennas configured to receive and transmit orthogonally polarized signals rotated relative to the horizontal and vertical axes of respective ground planes of the patch antennas. The method includes:
for each of the patch antennas:
using a calibration line, activating the patch antenna to obtain a first calibration signal for a first one of the polarizations;
using the calibration line, activating the patch antenna to obtain a second calibration signal for a second one of the polarizations; and
determining, from the first and second calibration signals, respective propagation parameters for each of the polarizations; and
providing the determined propagation parameters as correction factors to a beam steering controller of the phased array antenna, thereby performing calibration of both of the orthogonal polarizations using the same calibration line.

According to some embodiments of the invention, for calibrating an antenna transmit mode the patch antenna is activated by inputting a radio frequency (RF) signal to the patch antenna via respective transmit/receive (T/R) modules for the first and second polarizations, and the first and second calibration signals are detected on the calibration line.

According to some embodiments of the invention, for calibrating an antenna receive mode the patch antenna is activated by inputting an RF signal to the calibration line, and the first and second calibration signals are output by respective transmit/receive (T/R) modules for the first and second polarizations.

According to some embodiments of the invention, the propagation parameters are derived from at least one of a difference between the respective phases of a signal used to activate the patch antenna and the calibration signal and a difference between the respective amplitudes of the signal used to activate the patch antenna and the calibration signal.

According to some embodiments of the invention, determining the respective propagation parameters is performed by digital signal processing of the first and second calibration signals.

According to some embodiments of the invention, determining the respective propagation parameters is performed by analog processing of the first and second calibration signals.

According to some embodiments of the invention, at least one of the patch antennas includes:
an upper patch radiator;
a lower patch radiator beneath the upper patch radiator;
an upper feed layer beneath the lower patch radiator, configured to couple a first feed line to the upper patch radiator;
a ground plane beneath the upper feed, having at least one slot aperture along the ground plane in a first direction and at least one slot aperture along the ground plane in a second direction orthogonal to the first direction, the first and second directions being rotated relative to the horizontal and vertical axes of the ground plane; and
a lower feed layer beneath the ground plane, configured to couple a second feed line to the lower patch radiator,
wherein the upper feed layer is coupled to the lower patch radiator via the at least one slot aperture along the ground plane in the first direction and the lower feed layer is coupled to the lower patch radiator via the at least one slot aperture along the ground plane in the second direction.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIG. 1 is a simplified diagram of the layers of a patch antenna, according to some embodiments of the invention;

FIG. 2 is a simplified block diagram of a patch antenna in a cavity, according to some embodiments of the invention;

FIG. 3 is a simplified block diagram of a patch antenna in a cavity, according to an exemplary embodiment of the invention;

FIG. 4 is a simplified block diagram of a patch antenna, according to some embodiments of the invention;

FIGS. 5A-5H are simplified illustrations of components of a patch antenna, according to an exemplary embodiment of the invention;

FIG. 6 is a simplified block diagram of a phased array antenna, according to embodiments of the invention;

FIG. 7 is a simplified method for steering a phased array antenna, according to some embodiments of the invention;

FIG. 8 is a simplified illustration of an exemplary phased array antenna, according to some embodiments of the invention;

FIGS. 9A-9C are simplified flowcharts of methods for calibrating a patch antenna in phased array antenna, according to some embodiments of the invention; and

FIGS. 10-11 are simulation results showing the isolation in the azimuth direction between the center element of the array and the surrounding radiating elements with different polarizations, for an exemplary embodiment of the antenna array described herein.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to a phased array antenna and, more particularly, but not exclusively, to a dual polarized phased array antenna.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### I. Patch Antenna

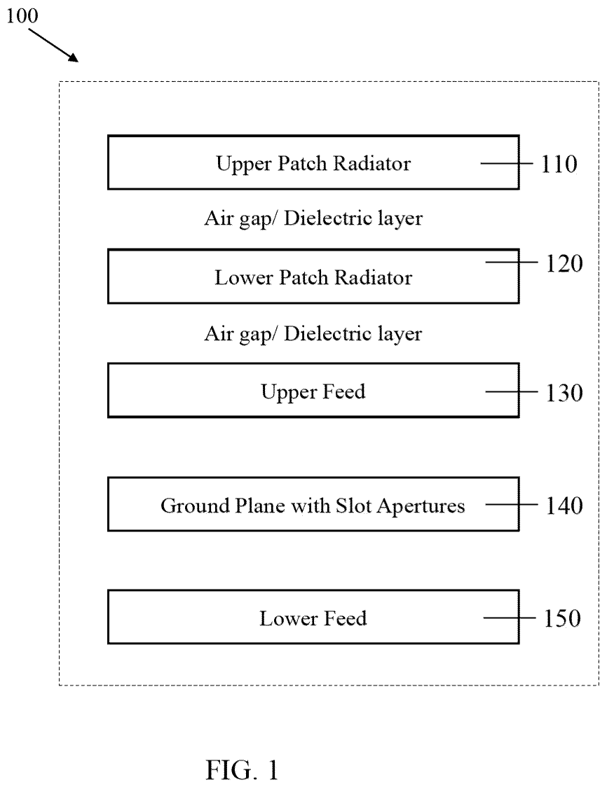

Referring now to the drawings, FIG. 1 is a simplified diagram of the layers of a patch antenna, according to some embodiments of the invention. In some embodiments, patch antenna 100 is a reciprocal antenna which has the same radiation pattern and polarization when transmitting as it does when receiving.

Patch antenna 100 includes stacked antenna elements. In some embodiments, patch antenna 100 includes at least the following layers:
i) Upper patch radiator 110—emits and/or receives a signal with a first polarization. Optionally, the upper layer is passive and serves to extend the bandwidth of the antenna;
ii) Lower patch radiator 120 beneath the upper patch radiator—emits and/or receives a signal with a second polarization;
iii) Upper feed 130 beneath lower patch radiator 120—couples a first feed line to lower patch radiator 120 via slot aperture(s) aligned in a first direction on ground plane 140;
iv) Ground plane 140 beneath upper feed 130—has slot apertures in two substantially orthogonal directions (e.g. along the patch diagonals). The orthogonal slot apertures enable the upper and lower patch radiators 110 and 120 to radiate in orthogonal polarizations; and
v) Lower feed layer 150 beneath ground plane 140—couples a second feed line to lower patch radiator 120 via slot aperture(s) aligned in a second direction on ground plane 140.

Upper patch radiator 110 is excited by lower patch radiator 120. Upper patch radiator 110 and lower patch radiator 120 resonate at slightly different resonant frequencies and as a result each patch radiator operates over a different frequency spectrum. The total bandwidth of patch antenna 100 is the combination of frequency spectrums of the lower and upper patch radiators. Thus, this architecture typically extends the bandwidth of patch antenna 100 beyond the bandwidth that would be obtainable with a single patch radiator.

Optionally, the lower patch radiator and/or the upper patch radiator have a symmetrical shape (e.g. square, circular, etc.).

As used herein, according to some embodiments of the invention, the term “antenna” means a device that converts electric current into electromagnetic waves and/or vice versa. The antenna architecture is based on the application it is used for, for example the wavelengths it is required to receive and/or transmit, transmission power, etc.

As used herein, according to some embodiments of the invention, the term “antenna element” means a component of the antenna that radiates.

As used herein, according to some embodiments of the invention, the term “phased array antenna” means an array of antennas that is controlled to produce a desired radiation pattern.

As used herein, according to some embodiments of the invention, the term “substantially orthogonal” means at a 90° angle to each other, within a tolerance permitting proper functioning of the antenna in the two polarizations.

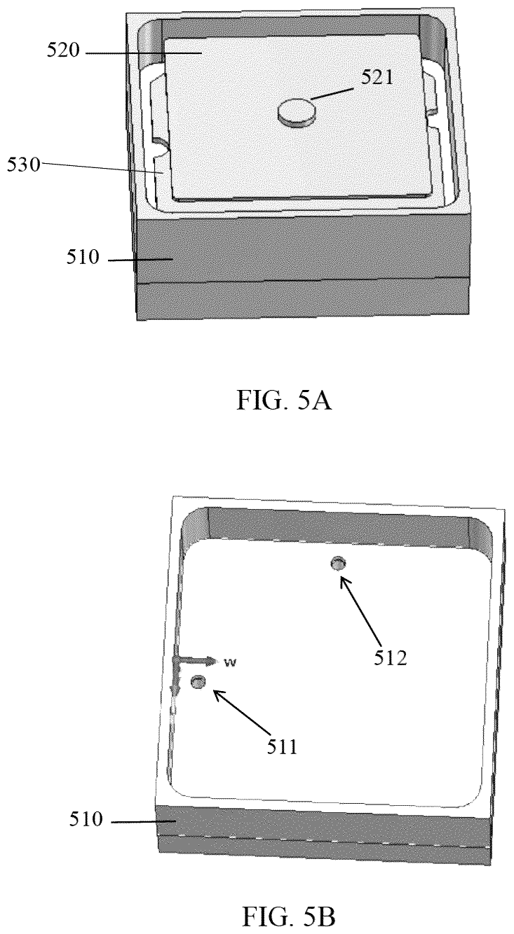

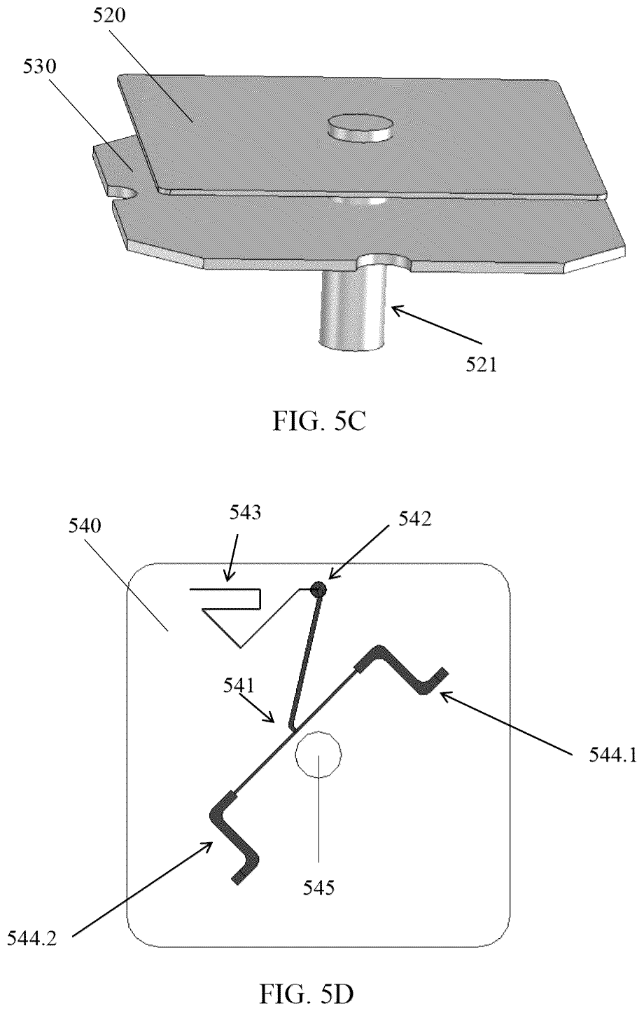

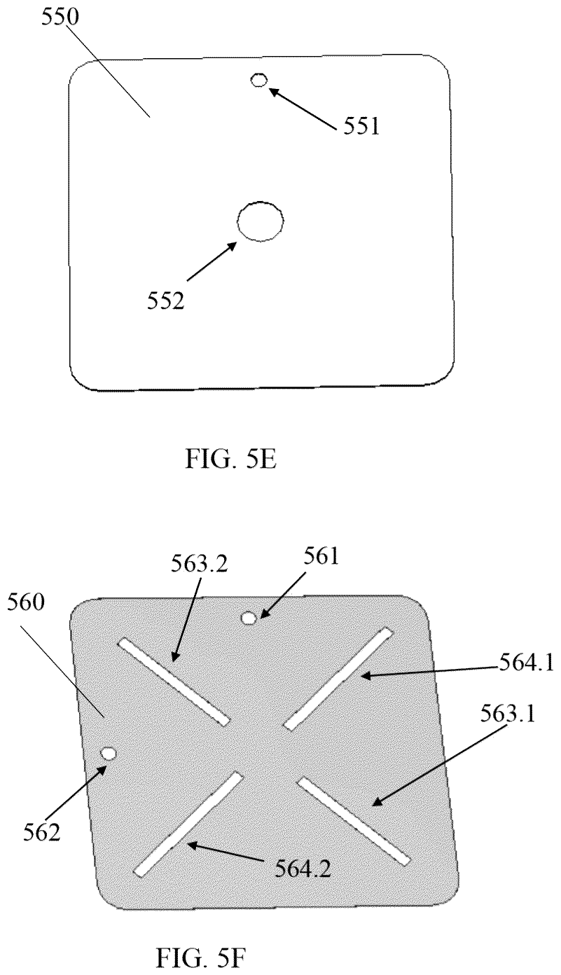

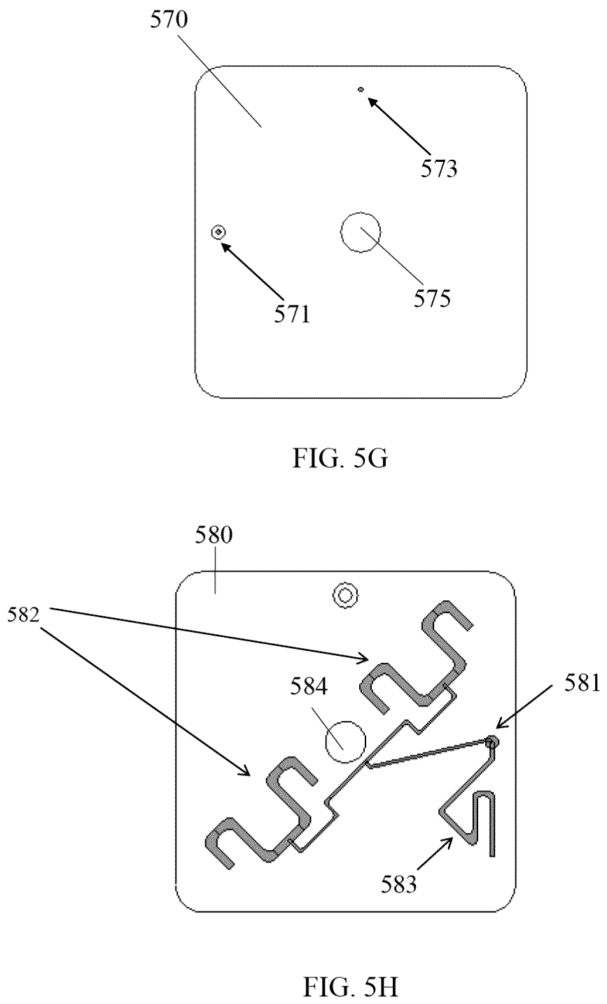

Optionally, wherein the orthogonal directions of the slot aperture on ground plane 140 are rotated relative to the horizontal and vertical axes of the ground plane. Thus the polarizations of patch antenna 100 does not operate with 0° and 90° degree polarizations. For example, in FIG. 5F (described in more detail below) slot apertures 563.1, 563.2, 564.1 and 564.2 are not aligned with the vertical and horizontal axes of ground plane 560, but rather are rotated to run along the diagonals of ground plane 560. FIG. 5F shows a non-limiting embodiment in which the slot apertures are rotated by 45°, however the degree of rotation may vary in other embodiments.

Optionally, the rotation of the slot aperture may be anywhere in the range of ±90°, meaning that the slot apertures may have any rotation that is not aligned with the ground plane horizontal and vertical axes.

Further optionally, the slot apertures are substantially aligned with diagonals of the ground plane, so that upper patch radiator 110 and lower patch radiator 120 have +45degree polarization and −45 degree polarization respectively.

Optionally, upper patch radiator 110 and lower patch radiator 120 are separated by an air gap. Alternately, upper patch radiator 110 and lower patch radiator 120 are separated by a dielectric layer.

Optionally, lower patch radiator 120 and upper feed layer 130 are separated by an air gap. Alternately, lower patch radiator 120 and upper feed layer 130 are separated by a dielectric layer.

Thus embodiments of the invention may include four alternate architectures:
a. Upper patch radiator 110 and lower patch radiator 120 are separated by an air gap and lower patch radiator 120 and upper feed layer 130 are separated by an air gap;
b. Upper patch radiator 110 and lower patch radiator 120 are separated by an air gap and lower patch radiator 120 and upper feed layer 130 are separated by a dielectric layer;
c. Upper patch radiator 110 and lower patch radiator 120 are separated by a dielectric layer and lower patch radiator 120 and upper feed layer 130 are separated by an air gap; and
d. Upper patch radiator 110 and lower patch radiator 120 are separated by a dielectric layer and lower patch radiator 120 and upper feed layer 130 are separated by a dielectric layer.

Optionally the patch antenna includes one or more additional components, as described in more detail below.

Optionally, patch antenna 100 includes a top dielectric layer is located above upper patch radiator 110. Optionally, the top dielectric layer functions as a radome.

Optionally, the top dielectric layer matches the impedance of the antenna to free space when the antenna is scanned to far-out scan angles (e.g. Wide-Angle Impedance Matching).

Optionally, patch includes a substrate layer between upper feed layer 130 and ground plane 140.

Optionally, patch includes a substrate layer between lower feed layer 150 and ground plane 140.

Optionally, upper patch radiator 110 and lower patch radiator 120 are metallic layers. This makes them more physically robust relative to layers deposited on a substrate.

Optionally, patch antenna 100 includes a mechanical support element that supports the upper first patch radiator and the lower patch radiator over the ground plane through their respective centers (for example as shown in FIG. 5C). Further optionally, the mechanical support element runs through one or more other layers of the patch antenna (for example as shown in FIG. 5D).

Optionally, the mechanical support element is electrically non-conductive. The mechanical support element may thus serve to physically separate a metallic upper patch radiator and a metallic lower patch radiator and prevent electrical contact between them.

Optionally, the mechanical support is placed in the center of the two patches. In this case the mechanical support element may be electrically conductive since the electrical fields are null in the center of the patch.

Optionally, the feeds to upper feed layer 130 and lower feed layer 150 are conveyed via respective transmit/receive (T/R) modules. Each T/R module adjusts the phase and/or amplitude of the signal applied to the respective feed layer. The amplitude(s) and/or phases(s) are controlled by control signals. The T/R module may have any architecture suitable for controlling the phase and/or amplitude of an RF signal.

Optionally, the stacked antenna elements are located within a cavity. Locating the antenna elements within a cavity prevents surface waves and reduces mutual coupling between adjacent or nearby antennas. Further optionally, the cavity is metallic.

In some embodiments the cavity is formed with solid walls. In alternate embodiments the cavity is composed of pins with a small distance between pins (approximately one tenth of the RF signal wavelength). The use of pins may also be implemented within a dielectric by placing “vias” or plated-thru holes).

Exemplary embodiments of antenna cavities which may be suitable for the patch antenna described herein are presented in U.S. Pat. No. 7,298,333, which is incorporated in its entirety by reference into the specification.

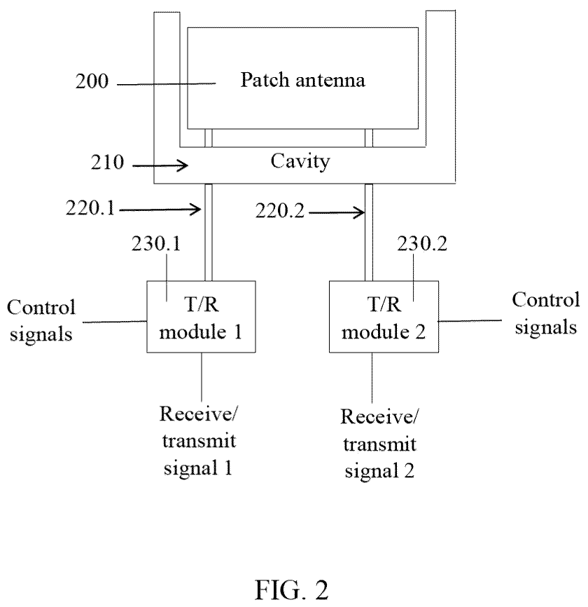

Reference is now made to FIG. 2, which is a simplified block diagram of a patch antenna in a cavity, according to embodiments of the invention. Patch antenna 200 is located within cavity 210. The dimensions, material, and other parameters of cavity 210 may be in accordance with any cavity appropriate for containing a patch antenna known in the art.

Patch antenna 200 may be in accordance with any embodiment of the patch antenna described herein. In some embodiments, patch antenna 200 includes an upper dielectric layer.

Optionally, cavity 210 has at least one hole, through which the feed lines 220.1 and 220.2 pass to the upper feed layer and the lower feed layer (for example holes 511 and 512 in FIG. 5B).

Optionally, RF signal feed lines 220.1 and 220.2 are conveyed to the patch antenna via respective T/R modules 230.1 and 230.2. Each T/R module adjusts the phase and/or amplitude of the signal applied to the respective feed layer. The amplitude(s) and/or phases(s) are controlled by control signals. Optionally T/R modules 230.1 and 230.2 are capable of adjusting the phase and amplitude of both received and transmitted RF signals.

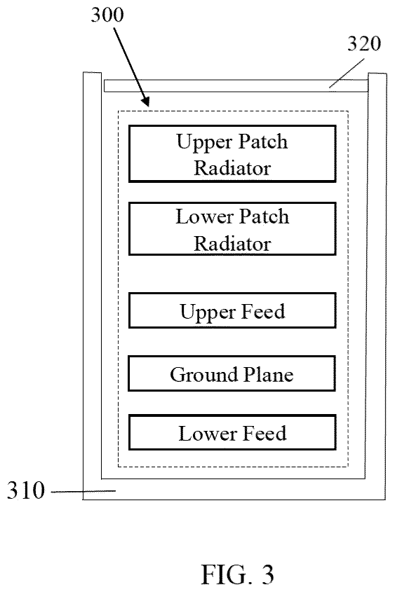

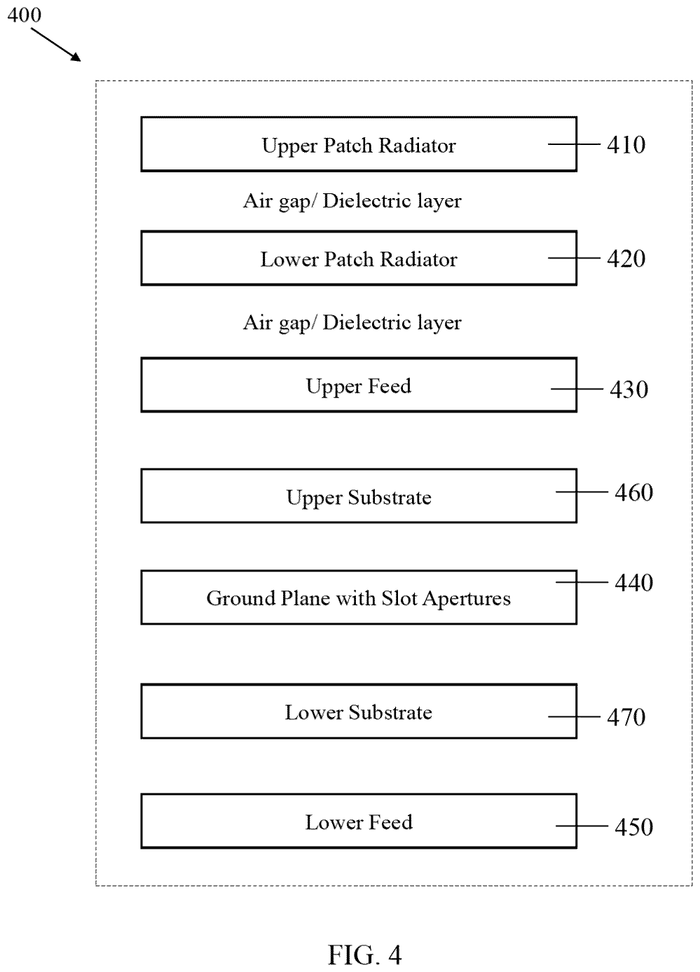

Reference is now made to FIG. 3, which is a simplified block diagram of a patch antenna in a cavity, according to an exemplary embodiment of the invention. Patch antenna 300 is located in cavity 310. In this non-limiting example patch antenna 300 includes the layers shown in FIG. 1 and upper dielectric layer 320. In other embodiments, antenna 300 includes additional layers as described herein (e.g. the antenna architecture of FIG. 4).

Reference is now made to FIG. 4, which is a simplified block diagram of a patch antenna, according to some embodiments of the invention. Antenna 400 includes the layers illustrated in FIG. 1, with the addition of upper substrate layer 460 and lower substrate layer 470. Upper substrate layer 460 supports upper feed layer 430 and lower substrate layer 460 supports ground plane 440. The dielectric constant, dimensions and other physical properties of the substrate layers may be selected to achieve the required performance of the antenna (e.g. bandwidth, maximum operating power, etc.).

Examples of materials that may be used as substrates include but are not limited to: polytetrafluoroethylene (PTFE), epoxy glass, ceramics, foam, polystyrene, Poly (methyl methacrylate) (PMMA), fused quartz, alumina, and silicon.

### II. Exemplary Patch Antenna

Reference is now made to FIGS. 5A-5H, which are simplified illustrations of components of a patch antenna, according to an exemplary embodiment of the invention. The shapes, connections, circuitry, and other aspects shown herein are non-limiting with regard to other possible embodiments of the invention.

FIG. 5A illustrates a patch antenna in cavity 510. The patch antenna includes the antenna element layers shown schematically in FIG. 4, though not all the antenna elements are visible in FIG. 5A. Upper patch radiator 520 and lower patch radiator 530 are described in more detail below. Support element 521 passes through holes in the center of the patch antenna elements and provides mechanical support. Support element 521 may also serve to create an air gap below upper patch radiator 520 and/or lower patch radiator 530 when they are not followed by a dielectric layer.

FIG. 5B illustrates an exemplary patch antenna cavity 510. Cavity 510 has two openings 511 and 512, through which the feed lines pass to reach the upper and lower feeds.

FIG. 5C illustrates an exemplary upper patch radiator 520 and exemplary lower patch radiator 530, which are mechanically connected to support element 521. The shapes of upper patch radiator 520 and lower patch radiator 530 are not limiting. The shapes, dimensions and materials used to construct each patch may be selected to meet the requirements of the given implementation (e.g. radiation pattern).

FIG. 5D is a top view of an exemplary upper feed 540. Feed input 542 is connected to splitter 541, which splits or combines the signals to/from radiating elements 544.1 and 544.2. Radiating elements 544.1 and 544.2 emit signals in a first polarization. Line 543 is connected to the other side of feed input 542 for impedance matching. The support element passes through hole 545, which is located in the center of upper feed 540.

FIG. 5E illustrates an exemplary upper substrate 550. Upper substrate 550 has an opening 551 through which the feed line passes to reach upper feed 540 and a hole 552 for the support element.

FIG. 5F illustrates an exemplary ground plane 560. Ground plane 560 has four slot apertures. Slot apertures 563.1 and 563.2 are aligned along one diagonal of ground plane 560 and slot apertures 564.1 and 564.2 are aligned along the second diagonal of ground plane 560, yielding orthogonal pairs of slot apertures. Slot apertures 563.1 and 563.2 are aligned with the radiating elements of upper feed 540. Slot apertures 564.1 and 564.2 are aligned with the radiating elements of lower feed 580. Thus upper patch radiator 520 and lower patch radiator 530 have +45° and −45° polarizations.

FIG. 5G illustrates an exemplary lower substrate 570. The feed line to upper feed 540 passes through hole 571. Pin 573 passes through the lower substrate and attaches to the upper feed line, which is printed on the upper substrate. The support element passes through hole 575.

FIG. 5H is a bottom view of an exemplary lower feed 580. Feed input 581 is connected to circuit 582, which includes three splitters and four radiating elements. Line 583 is connected to the other side of feed input 581 for impedance matching. The support element passes through hole 584, which is located in the center of lower feed 580. Ground plane slot apertures 564.1 and 564.2 are aligned with the lower feed radiating elements which emit signals at the second polarization, which is orthogonal to the polarization of upper feed 540.

### III. Phased Array Antenna

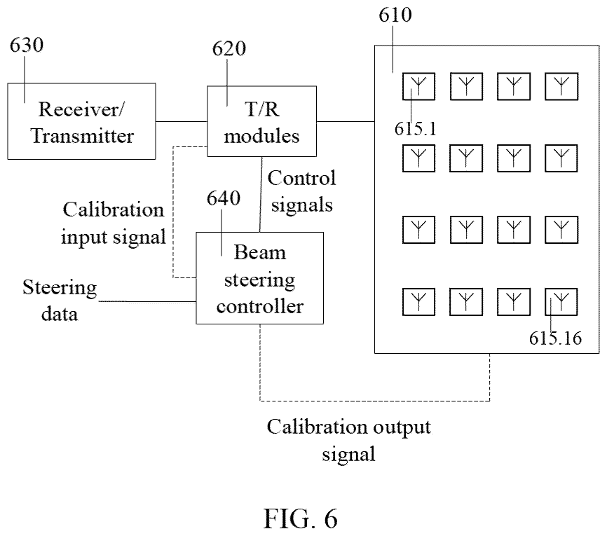

Reference is now made to FIG. 6, which is a simplified block diagram of a phased array antenna, according to some embodiments of the invention.

The phased array antenna includes patch antenna array 610 and T/R modules 620. For clarity, patch antenna array 610 is illustrated in a non-limiting manner as a four by four array of patch antennas 615.1-615.16. As will be appreciated by the skilled person, other configurations of patch antennas may be used.

Optionally, each of the patch antennas includes:
i) an upper patch radiator;
ii) a lower patch radiator below the upper patch radiator; and
iii) a ground plane.

The ground plane is located below the lower patch radiator and includes at least one slot aperture in a first direction and at least one slot aperture in a second direction. The two directions are substantially orthogonal to each other.

The lower patch radiator is coupled to an upper feed layer positioned between the lower patch radiator and the ground plane via slot apertures along one direction. The lower patch radiator is also coupled to a lower feed layer positioned below the ground plane via slot apertures along the second direction.

Optionally, the orthogonal directions for at least one of the patch antennas are rotated relative to the horizontal and vertical axes of the respective ground plane. Further optionally, for at least one of the patch antennas the upper patch radiator and the lower patch radiator are configured to have +45 degree polarization and −45 degree polarization respectively.

Optionally, at least one of the patch antennas is located in a respective cavity.

Optionally, at least one of the patch antennas includes a top dielectric layer above the upper patch radiator.

T/R modules 620 adjust the respective phases and amplitudes of signals transmitted by and/or received from the upper patch radiators and the lower patch radiators. The phases and amplitudes are adjusted based on respective control signals provided to T/R modules 620.

Optionally, the phased array antenna includes beam steering controller 640 which steers the phased array antenna beam by generating the control signals for T/R modules 620. Beam steering controller 640 may include analog and/or digital circuitry.

Optionally, beam steering controller 640 includes at least one data processor, which may serve, for example, to determine the respective magnitudes of the control signals to obtain a specified scan angle. Optionally, the direction is determined from steering data obtained from a system controller.

Optionally, beam steering controller 640 includes at least one memory (volatile and/or non-volatile) for storing instructions for execution by the processor and/or data.

Optionally, beam steering controller 640 includes at least one analog to digital (A/D) converter that generates analog control signals for the T/R elements.

Alternately or additionally, the A/D converter(s) digitize calibration output signals returned from antenna array 610 during a calibration process. Beam steering circuitry may use the digitized calibration signals to calculate correction factors for the control signals in order to steer the antenna beam accurately.

Optionally, beam steering controller 640 includes a digital signal processor for processing the digitized calibration signals.

Optionally, phased array antenna 610 is connected via T/R modules 620 to a receiver and/or transmitter, shown schematically as receiver/transmitter 630.

In some embodiments of the invention, the phased array antenna includes at least one calibration line running between the patch antennas 615. During the calibration process, a calibration input signal is provided to each polarization of the individual patch antennas and/or groups of patch antennas in turn. The amplitude and phase shift of the resulting output calibration signal are measured, and respective amplitude and phase correction factors are calculated for each polarization of the patch antenna and/or group of patch antennas.

Optionally, the propagation parameters for both polarizations of at least one of the patch antennas are calibrated based on calibration measurements obtained using the same calibration line, as described in more detail below.

Optionally, calculating the correction factors from the calibration output signals is performed by beam steering controller 640.

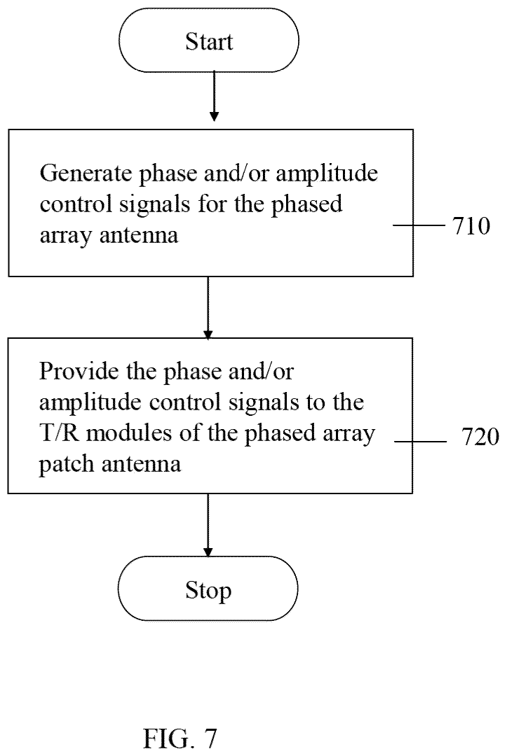

Reference is now made to FIG. 7, which is a simplified method for steering a phased array antenna, according to some embodiments of the invention.

In 710, control signals respective control signals are generated for the patch antennas of a phased array antenna so as to obtain a specified scan angle. The phased array antenna includes an array of patch antennas and T/R modules for adjusting respective phases and/or amplitudes of the patch antennas. The patch antennas in the array may be any embodiment of the patch antenna described herein.

Optionally, each of the patch antennas includes:
i) an upper patch radiator;
ii) a lower patch radiator below the upper patch radiator; and
iii) a ground plane.

The ground plane is located below the lower patch radiator and includes at least one slot aperture in a first direction and at least one slot aperture in a second direction. The two directions are substantially orthogonal to each other.

The lower patch radiator is coupled to an upper feed layer positioned between the lower patch radiator and the ground plane via slot apertures along one direction. The lower patch radiator is also coupled to a lower feed layer positioned below the ground plane via slot apertures along the second direction.

Optionally, the orthogonal directions for at least one of the patch antennas are rotated relative to the horizontal and vertical axes of the respective ground plane. Further optionally, for at least one of the patch antennas the upper patch radiator and the lower patch radiator are configured to have +45 degree polarization and −45 degree polarization respectively.

Optionally, at least one of the patch antennas is located in a respective cavity.

Optionally, at least one of the patch antennas includes a top dielectric layer above the upper patch radiator.

Optionally, the method further includes calculating correction factors for the control signals for both of the polarizations of at least one of the patch antennas. Further optionally, both polarizations are calibrated using the same calibration line.

Embodiments for calibrating the patch antenna are described in more detail below.

Optionally, the method further includes generating the control signals for the T/R modules based on the correction factors and the desired scan angle.

In 720, the control signals are provided to the T/R modules.

### IV. Calibration

According to some embodiments of the invention, a phased array antenna includes an array of patch antenna and at least one calibration line running between the patch antennas. The patch antennas emit orthogonally polarized signals that are rotated relative to the horizontal and vertical axes of respective ground planes of each of the patch antennas. When the patch antennas operate at or near +45° and −45° polarizations, both polarizations are strongly coupled to the calibration line. At other rotated polarizations, one of the polarizations may couple more strongly to the calibration.

Optionally, both polarizations are calibrated using a single calibration network as described herein.

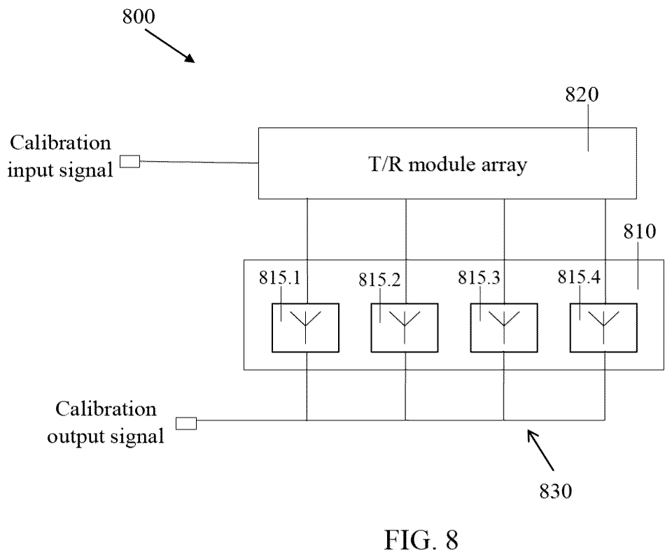

FIG. 8 is a simplified illustration of an exemplary phased array antenna which may be calibrated according to some embodiments of the invention. For clarity, patch antenna array 800 is illustrated in a non-limiting manner as an array of four dual-polarization patch antennas 815.1-815.4 and a single calibration line 830. As will be appreciated by the skilled person, other configurations of patch antennas and/or of calibration lines may be used.

T/R module array 820 adjusts the phase and/or amplitude of the RF signals received and/or transmitted by patch antennas 815.1-815.4.

Optionally, T/R module array 820 includes two T/R modules for each patch antenna in the array. Each T/R module controls a different polarization. For a given patch antenna, one of the T/R modules adjusts the phase and amplitude of the signal into the upper feed and the other T/R module adjusts the phase and amplitude of the signal into the lower feed.

In some embodiments, during calibration of the antenna array each polarization of each patch antenna is calibrated separately. One of the T/R modules is turned on, while all the other T/R modules are shut down. When that polarization is fully calibrated the T/R module is turned off, and the next module is turned on in order to calibrate the second polarization. This process repeats until all the patch antennas are calibrated at both polarizations. Since each polarization has its own T/R module there is no need to calibrate the two polarizations using different calibration networks.

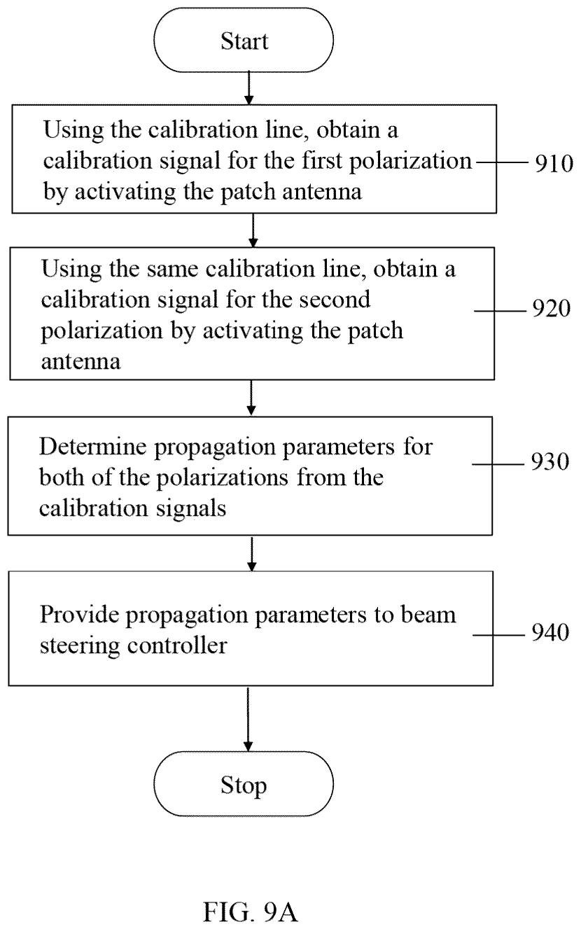

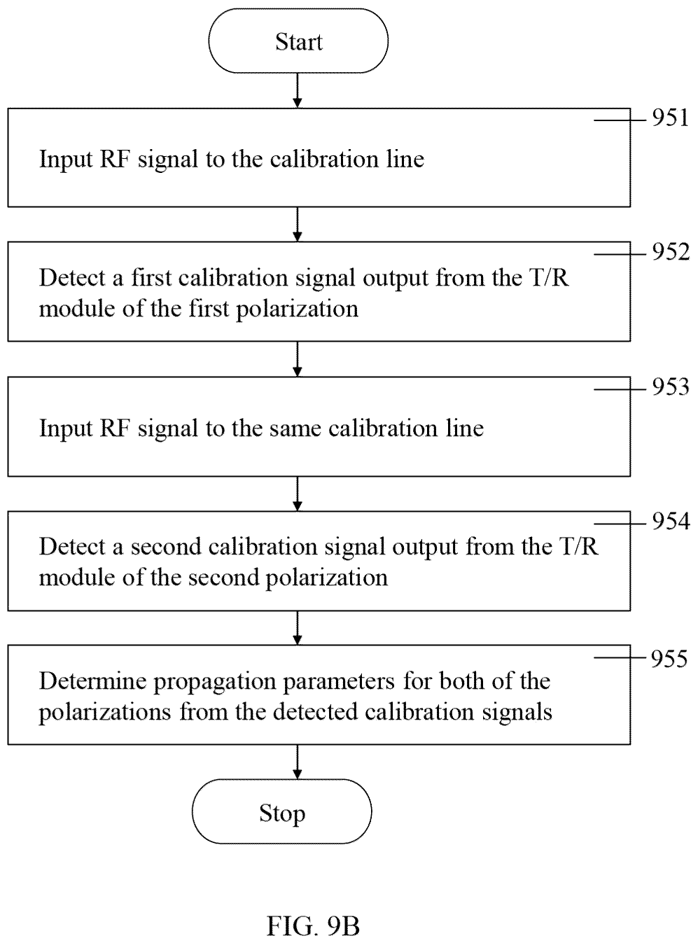

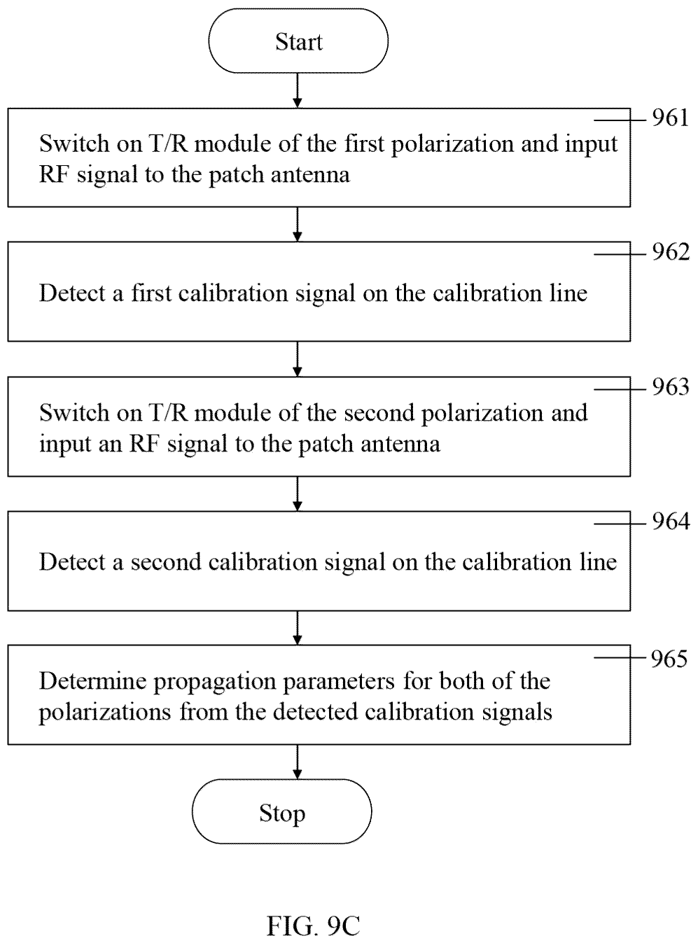

Reference is now made to FIGS. 9A-9C, which are simplified flowcharts of methods for calibrating a patch antenna in phased array antenna, according to some embodiments of the invention.

FIG. 9A is a simplified flowchart of a method for calibrating two polarizations of a single patch antenna using the same calibration line, according to embodiments of the invention. The calibration line may be part of a calibration network. Multiple patch antennas may be calibrated by activating them in turn and performing 910-940 for each patch antenna separately.

In 910, the patch antenna is activated using the calibration line, in order to obtain a calibration signal for one of the polarizations. The activation process is described in more detail below.

In 920, the patch antenna is activated using the calibration line, in order to obtain a calibration signal for the second polarization.

In 930, propagation parameters for each of the polarizations are determined from the respective calibration signals.

Optionally, in 940 the propagation parameters are provided as correction factors to the beam steering controller of the phased array antenna. FIG. 9A illustrates an optional embodiment in which the propagation parameters are provided after they been determined for an individual patch antenna. In other embodiments propagation parameters for multiple patch antennas (e.g. all the patch antennas in the array) are provided together.

Thus both of the orthogonal polarizations may be calibrated using a single calibration line.

Determining the propagation parameters from the calibration signals may be performed according to any technique known in the art that is suitable for a dual-polarization phased array antenna.

Optionally, the propagation parameters are derived (e.g. calculated) from one or both of:
1) The phase difference between the signal used to activate the patch antenna and the calibration signal from the antenna; and
2) The amplitude difference between the signal used to activate the patch antenna and the calibration signal from the antenna.

FIG. 9A shows a non-limiting embodiment in which the propagation parameters for both polarizations are calculated after both calibration signals have been detected. In other optional embodiments the propagation parameters are determined at different stages of the method. For example, the propagation parameters for the first polarization may be determined prior to and/or during activation of the patch antenna at the second polarization.

As used herein, the term “activating a patch antenna” means inputting or coupling an RF signal to the patch antenna.

As used herein, the term “using a calibration line” encompasses both inputting a signal to the calibration line and outputting a signal from the calibration line.

As used herein the term “calibration signal” means a signal output by the patch antenna while it is activated. As described in more detail below, the calibration signal may be output by the patch antenna to a T/R module or may couple to the calibration line from the patch antenna, depending on whether the patch antenna is being calibrated for receive mode or transmit mode.

Optionally, when calibrating a patch antenna for receive mode, the patch antenna is activated by inputting an RF signal to the calibration line. The T/R module for each polarization is switched on in turn. The calibration signals for the two polarizations are detected on the output of the switched-on T/R module.

Reference is now made to FIG. 9B, which is a simplified flowchart for calibrating a dual-polarization patch antenna for receive mode, according to some embodiments of the invention. FIG. 9B shows a non-limiting embodiment in which the patch antenna is activated separately for each polarization. In other optional embodiments, the patch antenna is activated once for a given patch antenna (or for multiple patch antennas) and the T/R modules are switched on and off in order, thereby obtaining output calibration signals for both polarizations.

In 951, an RF signal is input to the calibration line. The RF signal couples to the patch antenna, which outputs signals to the T/R modules.

In 952, the T/R module for one of the polarizations is switched on and the first calibration signal is output by the active T/R module.

In 953, an RF signal is input to the calibration line. The RF signal couples to the patch antenna, which outputs signals to the T/R modules.

In 954, the T/R module for the second polarization is switched on and the second calibration signal is output by the active T/R module.

In 955, propagation parameters are determined for both polarizations from the respective calibration signals.

Optionally, when calibrating a patch antenna for transmit mode, the patch antenna is activated by inputting an RF signal to the patch antenna via respective T/R modules for the first and second polarizations. The calibration signals are detected on the calibration line.

Reference is now made to FIG. 9C, which is a simplified flowchart for calibrating a dual-polarization patch antenna for transmit mode, according to some embodiments of the invention.

In 961, the T/R module for one of the polarizations is switched on. The RF signal is input to the patch antenna through the active T/R module. The patch antenna output couples to the calibration line.

In 962, the calibration signal for the first polarization is detected on the calibration line.

In 963, the T/R module for the second polarization is switched on. The RF signal is input to the patch antenna through the active T/R module. The patch antenna output couples to the calibration line.

In 964, the calibration signal for the second polarization is detected on the calibration line.

In 965, propagation parameters are determined for both polarizations from the respective calibration signals.

Optionally, the respective propagation parameters are determined by analog and/or digital signal processing.

Optionally, at least one of the patch antennas forming the array is configured according to any one of the embodiments described with respect to FIGS. 1-4. Further optionally, the patch antenna includes:
i) an upper patch radiator;
ii) a lower patch radiator beneath the upper patch radiator;
iii) an upper feed layer beneath the lower patch radiator, configured to couple a first feed line to the upper patch radiator;
iv) a ground plane beneath the upper feed, having at least one slot aperture along the ground plane in a first direction and at least one slot aperture along the ground plane in a second direction orthogonal to the first direction, the first and second directions being rotated relative to the horizontal and vertical axes of the ground plane; and
v) a lower feed layer beneath the ground plane, configured to couple a second feed line to the upper patch radiator.

The upper feed layer is coupled to the lower patch radiator via the at least one slot aperture along the ground plane in the first direction and the lower feed layer is coupled to the lower patch radiator via the at least one slot aperture along the ground plane in the second direction.

### V. Results

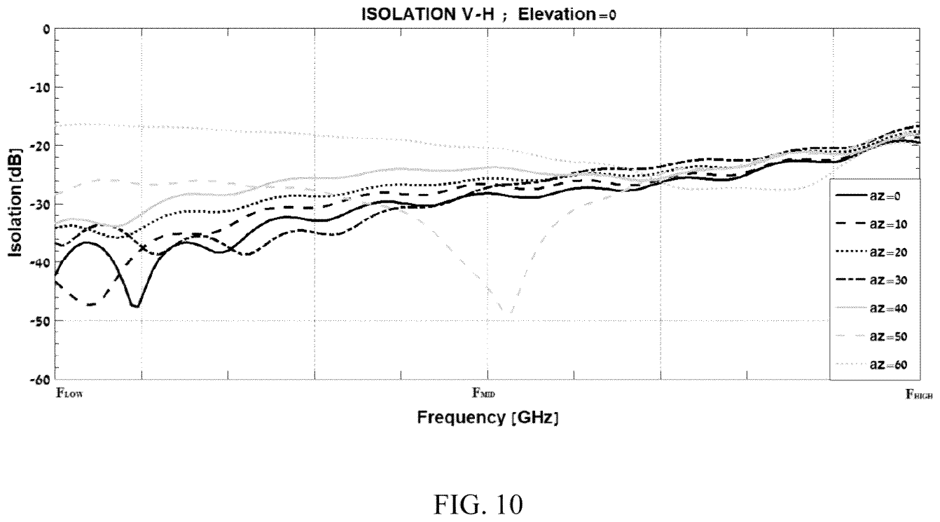

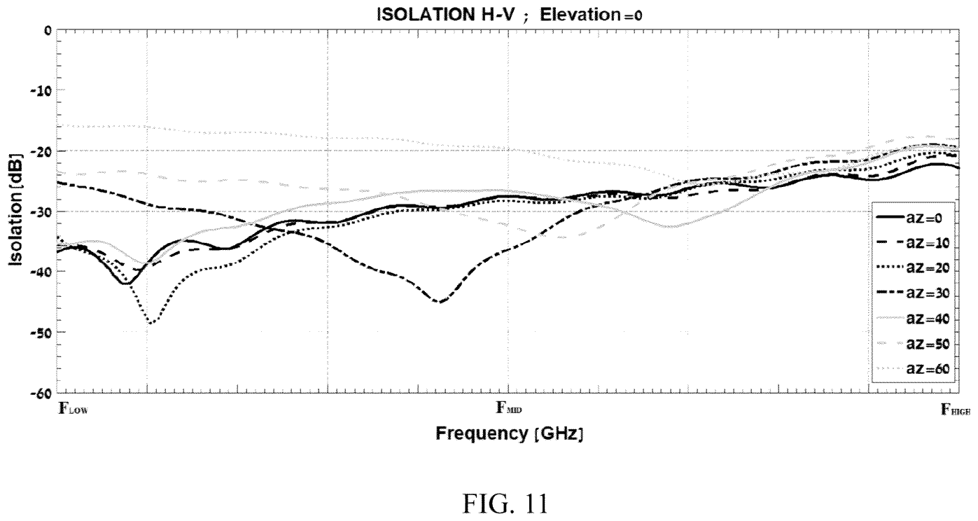

FIGS. 10-11 show simulation results of the isolation in the azimuth direction between the center element of the array and the surrounding radiating elements, for an exemplary embodiment of the antenna array as described herein.

FIG. 10 shows the isolation in the azimuth direction between the center element of the array and all the surrounding radiating elements. The center element is polarized in the +45° direction, while the surrounding elements are polarized in the −45° direction. Each curve shows the isolation for a particular scan angle as a function of frequency. The legend box on the right side lists the different scan angles. As can be seen, the isolation varies for each particular scan angle.

FIG. 11 shows the isolation in the azimuth direction between the center element of the array and all the surrounding radiating elements. The center element is polarized in the −45° direction, while the surrounding elements are polarized in the +45° direction. Each curve shows the isolation for a particular scan angle as a function of frequency. The legend box on the right side lists the different scan angles. Like in FIG. 10, the isolation varies for each particular scan angle.

### General

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1. A patch antenna, comprising a plurality of stacked antenna elements, said plurality of stacked antenna elements comprising:
an upper patch radiator;
a lower patch radiator beneath said upper patch radiator;
an upper feed layer beneath said lower patch radiator, configured to couple a first feed line to said upper patch radiator;
a ground plane beneath said upper feed, having at least one slot aperture along said ground plane in a first direction and at least one slot aperture along said ground plane in a second directional orthogonal to said first direction so as to obtain orthogonal polarizations; and
a lower feed layer beneath said ground plane, configured to couple a second feed line to said lower patch radiator,
wherein said upper feed layer is coupled to said lower patch radiator via said at least one slot aperture along said ground plane in said first direction and said lower feed layer is coupled to said lower patch radiator via said at least one slot aperture along said ground plane in said second direction.

2. The patch antenna according to claim 1, wherein said antenna elements are located within a cavity.

3. The patch antenna according to claim 1, further comprising a top dielectric layer above said upper patch radiator.

4. The patch antenna according to claim 1, wherein said first direction and said second direction are aligned with diagonals of said ground plane, so that said upper patch radiator and said lower patch radiator have +45 degree polarization and −45 degree polarization respectively.

5. The patch antenna according to claim 1, wherein said orthogonal directions are rotated relative to the horizontal and vertical axes of said ground plane.

6. The patch antenna according to claim 1, further comprising a first transmit/receive (T/R) module configured for adjusting at least one of a phase and an amplitude of a signal applied to said upper feed layer and a second T/R module configured for adjusting at least one of a phase and an amplitude of a signal applied to said lower feed layer.

7. The patch antenna according to claim 1, wherein said upper patch radiator is separated from said lower patch radiator by one of an air gap and a dielectric layer and said lower patch radiator is separated from said upper feed layer by one of an air gap and a dielectric layer.

8. The patch antenna according to claim 1, further comprising a first substrate layer between said upper feed layer and said ground plane.

9. The patch antenna according to claim 1, further comprising a second substrate layer between said lower feed layer and said ground plane.

10. The patch antenna according to claim 1, wherein said upper patch radiator and said lower patch radiator comprise metallic layers.

11. The patch antenna according to claim 1, further comprising a mechanical support element supporting said upper first patch radiator and said lower patch radiator over said ground plane through their respective centers.

12. A phased array antenna, comprising:
an array of patch antennas, each of said patch antennas respectively comprising:
an upper patch radiator;
a lower patch radiator below said upper patch radiator; and
a ground plane below said lower patch radiator, said ground plane comprising at least one slot aperture along said ground plane in a first direction and at least one slot aperture along said ground plane in a second direction substantially orthogonal to said first direction, wherein said lower patch radiator is coupled to an upper feed layer positioned between said lower patch radiator and said ground plane and to a lower feed layer positioned below said ground plane via slot apertures along respective ones of said orthogonal directions; and
a plurality of transmit/receive (T/R) modules associated with said respective upper feed layers and said respective lower feed layers of said plurality of patch antennas, configured to adjust at least one of a respective phase and a respective amplitude of signals applied to said upper patch radiators and to said lower patch radiators in accordance with respective control signals, so as to steer a beam of said phased array antenna.

13. The phased array antenna according to claim 12, wherein each of said patch antennas is located in a respective cavity, and wherein each of said patch antennas comprises a respective top dielectric layer above said upper patch radiator.

14. The phased array antenna according to claim 12, wherein for at least one of said patch antennas said upper patch radiator and said lower patch radiator are configured to have +45 degree polarization and −45 degree polarization respectively.

15. The phased array antenna according to claim 12, wherein for at least one of said patch antennas said orthogonal directions are rotated relative to the horizontal and vertical axes of said ground plane.

16. The phased array antenna according to claim 14, further comprising at least one calibration line running between said plurality of patch antennas, wherein, for at least one of said patch antennas, propagation parameters for both said upper feed layer and said lower feed layer are calibrated using the same calibration line.

17. A method for steering a phased array antenna, comprising:
generating respective control signals for a phased array antenna, said phased array antenna comprising:
an array of patch antennas configured to emit orthogonally polarized signals, each of said patch antennas respectively comprising:
an upper patch radiator;
a lower patch radiator below said upper patch radiator; and
a ground plane below said lower patch radiator, said ground plane comprising at least one slot aperture along said ground plane in a first direction and at least one slot aperture along said ground plane in a second direction substantially orthogonal to said first direction, wherein said lower patch radiator is coupled to an upper feed layer positioned between said lower patch radiator and said ground plane and to a lower feed layer positioned below said ground plane via slot apertures along respective ones of said orthogonal directions; and
a plurality of transmit/receive (T/R) modules associated with said respective upper feed layers and said respective lower feed layers of said plurality of patch antennas, configured to adjust at least one of a respective phase and a respective amplitude signals applied to said upper patch radiators and to said lower patch radiators in accordance with respective control signals; and
providing said generated control signals to said respective T/R modules so as to obtain a specified scan angle.

18. The method of claim 17, wherein for at least one of said patch antennas said upper patch radiator and said lower patch radiator are configured to have +45 degree polarization and −45 degree polarization respectively.

19. The method of claim 17, wherein each of said patch antennas is located in a respective cavity, and wherein each of said patch antennas comprises a top dielectric layer above said upper patch radiator.

20. The method of claim 17, wherein said phased array patch antenna further comprises at least one calibration line running between said plurality of patch antennas, and said method further comprises calculating respective correction factors for each of said polarizations using a same calibration line.

21. A method for calibrating a phased array antenna, said phased array antenna comprising an array of patch antennas configured to receive and transmit orthogonally polarized signals rotated relative to the horizontal and vertical axes of respective ground planes of said patch antennas, said method comprising:
for each of said patch antennas:
using a calibration line, activating said patch antenna to obtain a first calibration signal for a first one of said polarizations;
using said calibration line, activating said patch antenna to obtain a second calibration signal for a second one of said polarizations; and
determining, from said first and second calibration signals, respective propagation parameters for each of said polarizations; and
providing said determined propagation parameters as correction factors to a beam steering controller of said phased array antenna, thereby performing calibration of both of said orthogonal polarizations using the same calibration line.

22. The method of claim 21, wherein for calibrating an antenna transmit mode said patch antenna is activated by inputting a radio frequency (RF) signal to said patch antenna via respective transmit/receive (T/R) modules for said first and second polarizations, and wherein said first and second calibration signals are detected on said calibration line.

23. The method of claim 21, wherein for calibrating an antenna receive mode said patch antenna is activated by inputting an RF signal to said calibration line, and wherein said first and second calibration signals are output by respective transmit/receive (T/R) modules for said first and second polarizations.

24. The method of claim 21, wherein said propagation parameters are derived from at least one of a difference between the respective phases of a signal used to activate the patch antenna and the calibration signal and a difference between the respective amplitudes of the signal used to activate the patch antenna and the calibration signal.

25. The method of claim 21, wherein at least one of said patch antennas comprises:
an upper patch radiator;
a lower patch radiator beneath said upper patch radiator;
an upper feed layer beneath said lower patch radiator, configured to couple a first feed line to said upper patch radiator;
a ground plane beneath said upper feed, having at least one slot aperture along said ground plane in a first direction and at least one slot aperture along said ground plane in a second direction orthogonal to said first direction, said first and second directions being rotated relative to the horizontal and vertical axes of said ground plane; and
a lower feed layer beneath said ground plane, configured to couple a second feed line to said lower patch radiator,
wherein said upper feed layer is coupled to said lower patch radiator via said at least one slot aperture along said ground plane in said first direction and said lower feed layer is coupled to said lower patch radiator via said at least one slot aperture along said ground plane in said second direction.
